(19) United States
(12) Patent Application Publication
(10) Pub. No.: US 2006/0059748 A1
(43) Pub. Date: Mar. 23, 2006

(54) Method for displaying a magnetized poster board

(76) Inventors: Catherine H. Wescott, Beavercreek, OH (US); Thomas S. Walker, Kettering, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/943,304

(22) Filed: Sep. 17, 2004

(51) Int. Cl. G09F 7/04

(52) U.S. Cl. 40/600

(57) ABSTRACT

A method for display including the steps of providing a sheet-like poster board including a display panel with a front surface and a back surface, and a permanently magnetized portion located on the back surface. The method includes the steps of manually marking on the display surface and placing the magnetized portion against a magnetizable mounting surface to thereby magnetically mount the poster board to the mounting surface.

### FIELD

The present invention is directed to a poster board display system, and more particularly, to a poster board display system having a magnetized portion.

### BACKGROUND

Business enterprises, individuals, schools and other organizations often use poster boards as a means of communication and decoration, as well as for advertisements, presentations and artwork. Poster boards are typically used for temporary display and are frequently attached to a mounting surface. Users may manually mark or draw on the poster boards to create a personalized or individualized display. However, it can be difficult to attach the poster board to a mounting surface in a secure manner.

Accordingly, there is a need for a poster board that can be easily and securely coupled to a mounting surface.

### SUMMARY

The present invention utilizes a poster board with a magnetized portion that can be coupled to a magnetizable mounting surface, such as a metal mounting surface. In particular, in one embodiment the invention is a method for display including the steps of providing a sheet-like poster board including a display panel with a front surface and a back surface, and a permanently magnetized portion located on the back surface. The method includes the steps of manually marking on the display surface and placing the magnetized portion against a magnetizable mounting surface to thereby magnetically mount the poster board to the mounting surface.

### BRIEF DESCRIPTION OF THE DRAWINGS

FIG. 1 is a front view of one embodiment of the poster board, shown on a mounting surface;

FIG. 2 is a back view of the poster board of FIG. 1;

FIG. 3 is a cross-section of the poster board of FIG. 1; and

FIG. 4 is a cross-section of an alternate embodiment of the poster board.

### DETAILED DESCRIPTION

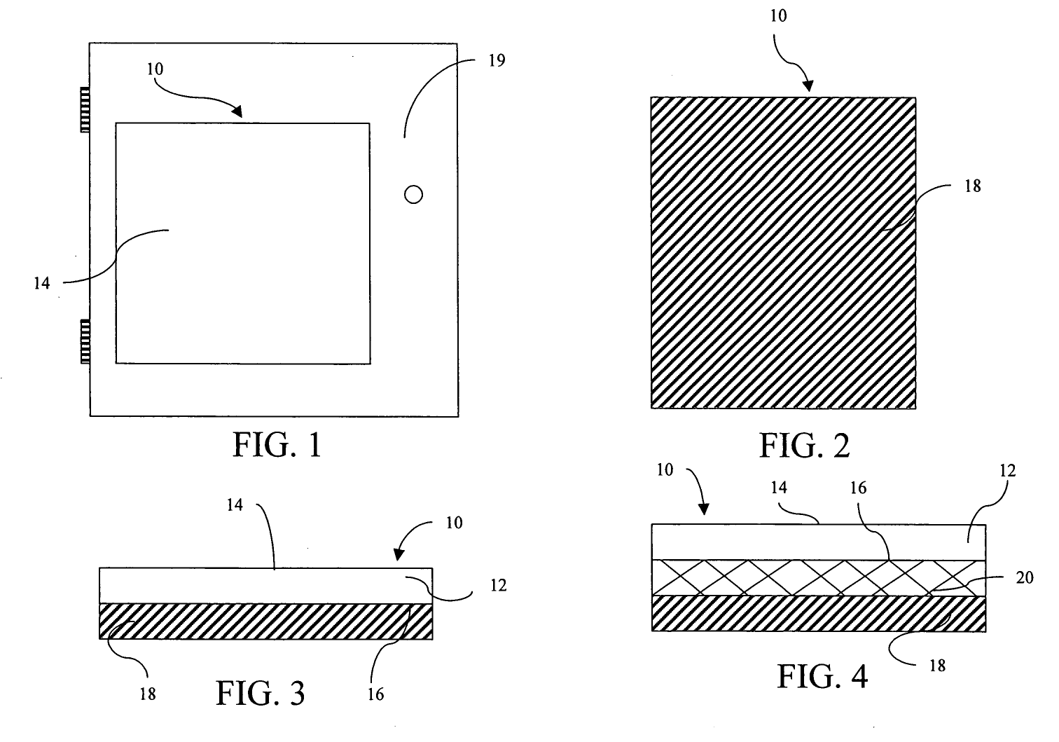

Referring to FIGS. 1-3, in one embodiment the poster board 10 includes a display panel 12 having a front surface 14 and a back surface 16 located on opposite sides of the display panel 12. The display panel 12 may be rectangular and may have a variety of sizes, for example 11 inches×14 inches, 22 inches×28 inches or 24 inches×36 inches. However, the display panel 12 may be any size or shape suitable for display and communication of information. The display panel 12 may be made of materials that allow a user to write thereon with a pen, pencil or the like, or upon which pre-printed graphics may be printed, such as paper or plastics. When the display panel 12 is made of paper, the display panel 12 may have a basic weight of eighty pounds, where the basic weight represents the weight of five hundred sheets of the material of standard size, such as 11 inches by 14 inches. The front surface 14 of the display panel 12 may be white, colored or multi-colored.

The poster board 10 may include a permanently magnetized portion 18 affixed to or located on the back surface 16 of the display panel 12 to allow the poster board 10 to be mounted to a magnetically attractive or magnetizable mounting surface 19. As used herein, “magnetized” means that magnetic properties have been induced in the object or that the object is producing an external magnetic field. As used herein, “magnetically attractive” or “magnetizable” means that the surface will attract or be allocated to a magnet or magnetized object.

The magnetized portion 18 may include ferromagnetic particles suspended in a thermoplastic binder as described in United States published patent application 2002/0081446, the entire contents of which are incorporated herein by reference. The '446 application is directed to a magnetic assembly including a thin magnetic layer directly adhered to a printable layer (such as a display panel) and a method of manufacturing the magnetic assembly. In one embodiment, the poster board may include the magnetic assembly described in the '446 application. The magnetized portion 18 may have a thickness of less than about 0.030 inches or less than about 0.006 inches or between about 0.002 inches and about 0.030 inches. In an alternate embodiment, the magnetic portion 18 has a thickness of between about 0.002 inches and about 0.020 inches. In yet another embodiment, the magnetic portion 18 has a thickness between about 0.002 inches and about 0.012 inches.

Referring now to FIG. 4, in another embodiment the poster board 10 includes an adhesive promoting layer 20 located between the back surface 16 of the display panel 12 and the magnetized portion 18. The use of the adhesive promoting layer 20 is described in detail in United States published patent application 2003/0077465, the entire contents of which are incorporated herein by reference. The adhesive promoting layer 20 may be made from a variety of materials, including, but not limited to, polymers such as polyolefin, polyurethanes, polyamide and the like. The adhesion promoting layer 20 may provide improved adhesion between the magnetized portion 18 and the back surface 16 without significantly increasing the total thickness or flexibility of the poster board 10.

In one embodiment of the poster board 10, the magnetized portion 18 may be coextensive with the back surface 16 of the display panel 12 and cover the entire back surface 16. In this case, the poster board 10 can be mounted on or to a magnetically attractive mounting surface 19 and the poster board 10 can lay flat against the surface 19 without curving or bowing. When the poster board 10 contacts the magnetically attractive mounting surface 19, the entire poster board 10 is drawn to the mounting to securely couple the poster board 10 to the mounting surface 19.

In addition, covering the entire back surface 16 with the magnetized portion 18 allows the poster board 10 to be more easily mounted on uneven mounting surfaces or mounting surfaces that include gaps. If the poster board 10 had only patches or discontinuous strips of the magnetized portion 18, a user would need to ensure that the magnetized portion 18 did not coincide with a gap in the mounting surface 19. Also, if the entire back surface 16 is covered with the magnetized portion 18, a user may trim or shape the poster board 10 without significantly affecting the magnetic properties of the poster board 10. Finally, if the entire back surface 16 is covered with the magnetized portion 18, the poster board 10 will be of a substantially uniform thickness, giving the poster board a smooth appearance when it is applied to a smooth mounting surface 19.

Covering the entire back surface 16 with the magnetized portion 18 has the added advantage of increasing the durability of the poster board, which allows the use of a thin display panel 12. In one embodiment, the display panel 12 may have a thickness of less than about 0.010 inches, or between about 0.003 inches and 0.010 inches. In an alternate embodiment, the display panel 12 may have a thickness of between about 0.003 inches and 0.008 inches. In yet another embodiment, the display panel 12 may have a thickness of between about 0.003 inches and 0.005 inches.

When the display panel 12 is covered by the magnetized portion 18, the poster board 10 may be relatively thin. In one embodiment the poster board 10 may have a total thickness of less than about 0.040 inches, or between about 0.005 inches and about 0.040 inches. In an alternate embodiment, the poster board 10 may have a total thickness of between about 0.005 inches and about 0.028 inches. In yet another embodiment, the poster board 10 may have a total thickness of between about 0.005 inches and about 0.016 inches. The thinness of the poster board 10 allows large quantities of the poster board 10 to be stored and shipped easily. In addition, the relative thinness of the poster board 10 and its proportionately light weight allows a relatively low magnetic attraction between the magnetic portion 18 and the magnetically attractive mounting surface 19 to secure the poster board 10 to the mounting surface 19.

The thinness of the poster board 10 may also allow it to be significantly rolled or curved without permanent deformation. Permanent deformation occurs when the poster board cannot return to a substantially planar state without the application of an outside force, or when the poster board becomes permanently creased, or when the poster board develops significant cracks. Rolled poster board, which is not permanently deformed, may be more easily stored and shipped. In one embodiment, the poster board 10 may be rolled into a cylinder with a diameter at least as low as about 2.5 inches without permanently deformation of the poster board 10. In another embodiment, the poster board 10 may be rolled into a cylinder with a diameter at least as low as about 1.60 inches without permanently deformation of the poster board 10. In a further embodiment, the poster board 10 may be rolled into a cylinder with a diameter at least as low as about 0.88 inches without permanently deformation of the poster board 10.

The thinness and resulting flexibility of the poster board 10 may also allow the poster board 10 to be mounted on non-planar or curved surfaces. The pliable nature of the poster board 10 may allow the poster board 10 to be molded around corners and into indentations, thereby maximizing the surface area of the magnetized portion 18 in contact with the magnetically attractive mounting surface 19. This maximizes the strength of the bond between the magnetized portion 18 and the magnetically attractive mounting surface 19. In addition, the poster board 10 may be significantly curved without permanent deformation, as discussed above. Therefore, the poster board 10 may be detached from an uneven or curved mounting surface 19 and reused on a mounting surface with an alternate shape or curvature.

Although the magnetized portion 18 is shown in FIG. 2 as covering the entire back surface 16, the invention is not limited to this embodiment and the magnetized portion 18 need not necessarily cover the entire back surface 16. For example, the magnetized portion 18 could take the form of strips that extend around the perimeter of the back surface 16, form a cross shape across the back surface 16, extend diagonally across the back surface 16, etc. Alternatively, the magnetized portion 18 could be in the form of patches located at the corners of the back surface 16 or distributed in various other manners across the back surface 16.

To utilize the poster board 10, a user may first write, draw or mark on the display surface 12 of the poster board 10 using pens, markers, pencils, crayons and the like. The user may then hold the poster board 10 up against a magnetically attractive mounting surface 19 to determine the appropriate position for the poster board 10. The poster board 10 is then pressed against the mounting surface 19 and the magnetized portion 18 and mounting surface 19 magnetically attract each other to thereby couple the poster board 10 against the mounting surface 19. The poster board may be removed from the mounting surface 19 and reattached or repositioned to multiple times. As outlined above, the mounting surface 19 can be nearly any magnetizable surface, such as metal surfaces including lockers, metal walls, metal supports, metal framing (i.e., for cubicles) refrigerators, metal cabinets, etc. Alternatively, the user may draw or mark on the display surface of the poster board 10 after the poster board 10 is positioned on the mounting surface 19.

In an alternate embodiment, the display surface 12 of the poster board 10 may include pre-printed graphics located thereon. For example, the display surface 12 may be pre-printed with a calendar grid, common phrases such as “For Sale,” or a common design such as party balloons. The user may manually add specific information such as event dates, prices or event information to the display surface 12.

The device and method shown herein allows a user to manually mark a poster board and mount the poster board to a magnetically attractive mounting surface. Once the poster board has served its purpose, the user may remove the poster board by simply pulling the poster board away from the mounting surface. The poster board may be mounted and removed from magnetically attractive mounting surfaces numerous times without affecting the mounting surface.

In order to manufacture the poster board 10 shown in FIGS. 1-3, the magnetic portions 18 are, in one embodiment, formed in a liquid solution for deposition on the display surface 12. In order to make the liquid slurry of the magnetic portions, a ferromagnetic material (such as ferrites) may be blended with a thermoplastic binder (such as polyurethane elastomers) at an elevated temperature. The ratio of ferromagnetic material to thermoplastic binder may be between about seventy percent and about ninety-five percent. Standard thermoplastic mixing equipment such as extruders or high shearing mixing equipment may be used to blend the ferromagnetic material with the thermoplastic binder. Once the ferromagnetic particles of the ferromagnetic material are suspended within the thermoplastic binder, the ferromagnetic/thermoplastic mixture may be allowed to cool for storage or shipment to a coating facility.

The solidified ferromagnetic/thermoplastic mixture 13 is then reformed into a liquid and deposited or coated on the display surface 12 using any of a variety of coating processes known in the art. In one embodiment, a high pressure extruder may be used to melt and pressurize the ferromagnetic/thermoplastic mixture. The ferromagnetic/thermoplastic mixture may be forced through an application head and deposited directly on to the display panel 12. The ferromagnetic/thermoplastic mixture may be applied to the display panel 12 while still in a pliable state. The ferromagnetic/thermoplastic mixture may be magnetized by providing a magnetic field as the ferromagnetic/thermoplastic mixture is applied to the display panel 12. The cooled, magnetized ferromagnetic/thermoplastic mixture comprises the magnetized portion 18 of the poster board.

As noted above, in an alternative embodiment, an adhesive promoting layer 20 is used. The adhesive promoting layer 20 may be applied to the display panel 12 using a nozzle just seconds prior to the application of the ferromagnetic/thermoplastic mixture, such that the adhesive promoting layer 20 is applied between the display panel 12 and the magnetized portion 18.

While particular embodiments of the present invention have been illustrated and described, it would be obvious to those skilled in the art that various additional changes and modifications can be made without departing from the spirit and scope of the present invention. It is therefore intended to cover in the appended claims all such changes and modifications that are within the scope of this invention.

What is claimed:

1. A method for display comprising the steps of:
providing a sheet-like poster board including a display panel with a front surface and a back surface, and a permanently magnetized portion located on said back surface;
manually marking on said display surface; and
placing the magnetized portion against a magnetizable mounting surface to thereby magnetically mount said poster board to said mounting surface.

2. The method of claim 1 wherein the magnetized portion has a thickness of less than about 0.006 inches.

3. The method of claim 1 wherein the magnetized portion has a thickness greater than about 0.002 inches.

4. The method of claim 1 wherein the poster board is substantially rectangular in front view.

5. The method of claim 4 wherein the dimensions of the poster board are one of: 8½ inches×11 inches, 11 inches×14 inches, 22 inches×28 inches, or 24 inches×36 inches.

6. The method of claim 1 wherein the front surface is non-white.

7. The method of claim 1 wherein the front surface includes preprinted graphics located thereon.

8. The method of claim 1 wherein the display panel is paper.

9. The method of claim 8 wherein the dimension of the poster board are about 11 inches×14 inches and the display panel has a basic weight of no more than about eighty pounds.

10. The method of claim 1 wherein the magnetized portion includes ferromagnetic particles in a binder adhered directly to the back surface of the display panel.

11. The method of claim 1 wherein the magnetized portion covers substantially the entire back surface of the display panel.

12. The method of claim 1 wherein the poster board may be rolled into a cylinder with a diameter as low as about 2.5 inches without permanently deforming the poster board.

13. The method of claim 1 wherein the poster board may be rolled into a cylinder with a diameter as low as about 1.60 inches without permanently deforming the poster board.

14. The method of claim 1 wherein the poster board may be rolled into a cylinder with a diameter as low as about 0.88 inches without permanently deforming the poster board.

15. The method of claim 1 wherein the marking step occurs prior to the placing step.

16. The method of claim 1 wherein the placing step occurs prior to the marking step.

17. The method of claim 1 wherein the display panel is a material capable of being marked upon by pen, pencil or crayon.

18. The method of claim 1 wherein the display panel is a relatively absorbent material.

19. The method of claim 1 wherein the display panel has a thickness of between about 0.003 inches and 0.010 inches.

20. The method of claim 1 wherein the display panel has a thickness of between about 0.003 inches and 0.008 inches.

21. The method of claim 1 wherein the display panel has a thickness of between about 0.003 inches and 0.005 inches.

22. The method of claim 1 wherein the poster board has a thickness of between about 0.005 inches and 0.040 inches.

23. The method of claim 1 wherein the poster board has a thickness of between about 0.005 inches and 0.028 inches.

24. The method of claim 1 wherein the poster board has a thickness of between about 0.005 inches and 0.016 inches.

25. A method for display comprising the steps of:
providing a sheet-like poster board including a display panel with a front surface and a back surface, and a permanently magnetized portion located on and substantially covering said back surface, the display panel being made of paper, the magnetized portion having a thickness of less than about 0.006 inches, where the poster board may be rolled into a cylinder with a diameter as low as 1.60 inches without permanently deforming the poster board;
manually marking on said display surface; and
placing the magnetized portion against a magnetizable mounting surface to thereby magnetically mount said poster board to said mounting surface.
